(19) United States
(12) Patent Application Publication
(10) Pub. No.: US 2026/0099331 A1
(43) Pub. Date: Apr. 9, 2026

(54) OPERAND-LESS INSTRUCTION SET ARCHITECTURE-BASED PROCESSOR AND COMPUTER HAVING THE SAME

(71) Applicant: COCOLINK INC., Seoul (KR)

(72) Inventor: Donghak LEE, Seoul (KR)

(73) Assignee: KoCOCOLINK INC., Seoul (KR)

(21) Appl. No.: 18/966,326

(22) Filed: Dec. 3, 2024

(30) Foreign Application Priority Data
Oct. 8, 2024 (KR) 10-2024-0136655

(51) Int. Cl. G06F 9/38; G06F 9/30; G06F 9/32

(52) U.S. Cl. CPC G06F 9/3802; G06F 9/3001; G06F 9/321

(57) ABSTRACT

It is disclosed that to an operand-less instruction set architecture-based processor and a computer having the operand-less instruction set architecture-based processor. An operand-less instruction set architecture-based processor includes an instruction processing unit configured to process program instructions that do not require operands, except for instructions related to receiving and transmitting data; one or more functional processing units configured to perform a plurality of functions for data processing; and a stacked register configured to separate instruction processing by the instruction processing unit from data processing by the functional processing unit.

### CROSS-REFERENCE TO RELATED APPLICATIONS

This application claims priority under 35 U.S.C. § 119 to Korean Patent Application No. 10-2024-0136655, filed on Oct. 8, 2024 in the Korean Intellectual Property Office (KIPO), the contents of which are herein incorporated by reference in their entirety.

### BACKGROUND OF THE INVENTION

### Technical Field

Exemplary embodiments of the present invention relate to an operand-less instruction set architecture-based processor and a computer having the operand-less instruction set architecture-based processor. More particularly, exemplary embodiments of the present invention relate to an operand-less instruction set architecture-based processor having a structure that maintains computational performance and consists of a minimal logic gate, and a computer having the operand-less instruction set architecture-based processor.

### Discussion of the Related Art

In recent years, computer architectures have shown a pattern of convergence toward huge matrix operations to solve AI problems. In particular, there has been an overwhelming increase in the proportion of tensor operations. However, although the proportion of tensor operations has increased significantly, it is not possible to build an application program using only tensor operations. In order to construct an application program, various operation functions are required, and the proportion of tensor operations is only overwhelmingly large.

As a method of maximizing the performance of computer systems in AI computation, a method of adding a computational function to memory in a von Neumann style computer structure has been proposed. In complex general scientific engineering applications, algorithms are complex and are not considered to be very effective. However, there is an opinion that significant performance improvement is expected in the field of AI. Based on this opinion, many companies and research institutes are trying to add computational functions to the memory area.

The method of operating in the memory area is divided into operating in memory (e.g., PIM, processing in memory) and operating near memory (e.g., PNM, processing near memory), both of which are connected to or contained in the memory rather than the central processor (CPU).

In this case, when the ALU of a general central processor is used as is, a circuit for configuring an additional arithmetic unit should be provided in the circuit for configuring the memory. Since there is a problem that the complexity of the memory is increased excessively, an arithmetic unit with a significantly reduced function is configured. In this case, the arithmetic unit in the PIM/PNM with reduced functionality is severely limited in terms of usability. PIM/PNM is used to further improve the performance of the computer system for various reasons, but it is not easy to enjoy the effect of performance improvement in practice.

Various methods are used to improve processor performance. That is, a complex instruction set is used, or multiple instruction pipelines or multiple computing devices are used. This application excessively increases the complexity of the circuit, resulting in an increase in the number of logic gates, an increase in power consumption, and an increase in heat generation. To improve this, production technology has been developed to reduce the line width of the circuit, but the line width becomes narrower than about 10 nm, which causes a new problem of heat and power due to the leakage current in the insulating section. In particular, in the case of the PIM processor core located in the memory, the instruction is minimized by greatly reducing the functionality, but the heat generation in the processor core and the heat generation in the memory cause a major problem in normalizing the performance.

To solve this problem, there is a need for new computer technology that can achieve high efficiency and low power consumption by maintaining the maximum required instruction and minimizing the number of logic gates.

### SUMMARY

Exemplary embodiments of the present invention provide an operand-less instruction set architecture-based processor having a structure for maintaining computational performance using a simple instruction set that does not include an operand and consists of a minimal logic gate.

Exemplary embodiments of the present invention provide an operand-less instruction set architecture-based computer including the above-described processor.

According to one aspect of the present invention, an operand-less instruction set architecture-based processor includes an instruction processing unit configured to process program instructions that do not require operands, except for instructions related to receiving and transmitting data; one or more functional processing units configured to perform a plurality of functions for data processing; and a stacked register configured to separate instruction processing by the instruction processing unit from data processing by the functional processing unit.

In an exemplary embodiment of the present invention, the instruction processing unit may include a program counter configured to store the memory address of the currently executing instruction, control the flow of the program, specify the address of the next instruction to execute, and increment the program counter value each time an instruction is executed to indicate the next instruction; an instruction loader configured to read instructions from external instruction memory; an instruction queue configured to store instructions loaded by the instruction loader, support continuous instruction processing, and provide quick access to instructions when needed; and an instruction processor configured to be respectively connected to the program counter, the instruction queue, and the functional processing unit.

In an exemplary embodiment of the present invention, the program counter may track the address of the next instruction by incrementing the counter based on the contents of the instruction queue.

In an exemplary embodiment of the present invention, the instruction queue may operate in units of bytes, and the instruction consists of 1 byte when there is no operand and 3 to 4 bytes when there is an operand to store the instruction.

In an exemplary embodiment of the present invention, the instruction processor may include an instruction fetcher configured to read instructions from the instruction queue and provide them to the functional processing unit; an instruction disassembler configured to interpret instructions and convert them into executable form; and a function selector configured to activate function modules within the functional processing unit.

In an exemplary embodiment of the present invention, the instruction disassembler may process instructions without an operand as a single byte and includes additional bytes in instructions with an operand to form a complete instruction.

In an exemplary embodiment of the present invention, the functional processing unit may include a first functional processing module corresponding to an arithmetic logic unit (ALU) having an arithmetic function; and a second functional processing module corresponding to a control unit having a control function.

In an exemplary embodiment of the present invention, the stacked register may include an ALU register accessed by the first functional processing module; and an FPU stack accessed by the stacker of the second functional processing module.

In an exemplary embodiment of the present invention, the FPU stack may include a register stack accessed by a stacker; and an operation-only register operated by an ALU.

In an exemplary embodiment of the present invention, the operation-only register may include a first direct access register that stores a first operand as input data; a second direct access register that stores a second operand as input data; and a result storage register that stores the result of an operation.

In an exemplary embodiment of the present invention, the first direct access register may be synchronized with, or identical to, the top of the register stack, and the second direct access register may be synchronized with, or identical to, the next top of the register stack.

In an exemplary embodiment of the present invention, the result storage register places the result value at the top of the register stack after the calculation operation is completed.

According to another aspect of the present invention, an operand-less instruction set architecture-based computer includes an instruction memory configured to store the instructions of the program; a data memory configured to store data necessary for the execution of the program; and a processor configured to read the program instructions from the instruction memory and to receive and transmit data from the data memory. In this case, the processor includes an instruction processing unit configured to process program instructions, but having no operand other than instructions for receiving and transmitting data; one or more functional processing units configured to perform a plurality of functions for data processing; and a stacked register configured to separate instruction processing by the instruction processing unit from data processing by the functional processing unit.

In an exemplary embodiment of the present invention, the instruction processing unit may include a program counter configured to store the memory address of the currently executing instruction, control the flow of the program, specify the address of the next instruction to execute, and increment the program counter value each time an instruction is executed to indicate the next instruction; an instruction loader configured to read instructions from external instruction memory; an instruction queue configured to store instructions loaded by the instruction loader, support continuous instruction processing, and provide quick access to instructions when needed; and an instruction processor configured to be respectively connected to the program counter, the instruction queue, and the functional processing unit.

In an exemplary embodiment of the present invention, the program counter may track the address of the next instruction by incrementing the counter based on the contents of the instruction queue.

In an exemplary embodiment of the present invention, the instruction queue may operate in units of bytes, and the instruction consists of 1 byte when there is no operand and 3 to 4 bytes when there is an operand to store the instruction.

In an exemplary embodiment of the present invention, the instruction processor may include an instruction fetcher configured to read instructions from the instruction queue and provide them to the functional processing unit; an instruction disassembler configured to interpret instructions and convert them into executable form; and a function selector configured to activate function modules within the functional processing unit.

In an exemplary embodiment of the present invention, the functional processing unit may include a first functional processing module corresponding to an arithmetic logic unit (ALU) having an arithmetic function; and a second functional processing module corresponding to a control unit having a control function.

In an exemplary embodiment of the present invention, the stacked register may include an ALU register accessed by the first functional processing module; and an FPU stack accessed by the stacker of the second functional processing module.

In an exemplary embodiment of the present invention, the FPU stack may include a register stack accessed by the stacker; and an operation-only register operated by the ALU.

According to the operand-less instruction set architecture-based processor and the computer having the operand-less instruction set architecture-based processor, it is possible to minimize the number of logic gates and maintain high efficiency by using a simple instruction set that does not include an operand. In addition, as the number of logic gates decreases, power consumption and heat generation can be reduced. In addition, since fewer logic gates are required, more processor cores can be integrated on semiconductor dies of the same size, which can be expected to improve performance.

### BRIEF DESCRIPTION OF THE DRAWINGS

The above and other features and aspects of the present invention will become more apparent by describing in detailed exemplary embodiments thereof with reference to the accompanying drawings, in which:

FIG. 1 is a block diagram explaining an operand-less instruction set architecture-based computer according to an exemplary embodiment of the present invention;

FIG. 2 is a diagram explaining a structure of the instruction processing unit shown in FIG. 1;

FIG. 3 is a diagram explaining a structure of the functional processing unit shown in FIG. 1 and FIG. 2;

FIG. 4 is a diagram explaining a structure of a stacked register shown in FIG. 3;

FIG. 5 is a diagram explaining an FPU stack structure as an example;

FIG. 6 is a diagram explaining an example of applying multiple functional processing units;

FIG. 7 is a diagram explaining an application of a multiple and multi-dimensional functional processing unit;

FIG. 8A and FIG. 8B are diagrams explaining a detailed instruction form; and

FIG. 9 is a diagram explaining an instruction table.

### DETAILED DESCRIPTION OF THE INVENTION

Hereinafter, embodiments of the present invention will be described in detail with reference to the accompanying drawings so that those skilled in the art may readily implement the present invention. However, the present invention may be implemented in a number of different forms and is not limited to the embodiments described herein. In addition, in order to clearly explain the present invention in the drawings, portions irrelevant to the description have been omitted and similar drawings have been attached to similar portions throughout the specification.

Throughout the specification, when a part is “connected” to another part, this includes not only “directly connected” but also “electrically connected” to another element in between. In addition, when a part “includes” a component, it means that it may include other components, not exclude others, unless otherwise indicated, and should be understood not to preclude the presence or addition of one or more other features, numbers, steps, actions, components, parts, or any combination thereof.

The terms “about,” “substantially,” and the like used throughout the specification are used in the figure or in a sense close to the figure when a manufacturing and material tolerance is unique to the meaning given and are used to prevent unscrupulous infringers from unfairly using the disclosure in which exact or absolute figures are given to aid in the understanding of the present invention. The term “step (to)” or “step (to) to a degree” used throughout the specification of the present invention does not mean “step for”.

In this specification, a “part” includes a unit realized by hardware, a unit realized by software, and a unit realized by both sides. In addition, a unit may be realized by two or more pieces of hardware, or two or more units may be realized by one piece of hardware. On the other hand, ‘˜part’ is not limited to software or hardware, and ‘˜part’ may be configured to be in a storage medium capable of addressing, or may be configured to play one or more processors. Therefore, as an example, ‘˜part’ includes components such as software components, object-oriented software components, class components, and task components, processes, functions, attributes, procedures, subroutines, program code segments, drivers, firmware, microcode, circuitry, databases, data structures, tables, arrays, and variables. Components and functions provided within a ˜part may be combined into a smaller number of components and ˜parts or further separated into additional components and ˜parts. In addition, components and ‘˜part’ may be implemented to play one or more CPUs in a device or secure multimedia card.

In this specification, some of the operations or functions described as being performed by a terminal, device, or appliance may instead be performed by a server connected to the terminal, device, or appliance. Likewise, some of the operations or functions described as being performed by a server may also be performed by a terminal, device, or appliance connected to that server.

In this specification, some of the operations or functions described as mapping or matching with the terminal may be interpreted as mapping or matching a unique number of the terminal or individual identification information that is identifying data of the terminal.

Hereinafter, the present invention will be described in detail with reference to the accompanying drawings.

General processors such as a complex instruction set computer (CISC) and a reduced instruction set computer (RISC) have been developed in the form of configuring multiple registers, multiple instruction processing units, and logic gates into a very complex structure to improve performance. However, even if the logic gates or the instruction processing unit is increased, the performance does not improve in proportion. The effect of performance improvement only meets expectations in very exceptional cases, and in many cases, it is insignificant compared to the increase in circuit complexity.

The present invention proposes a method of configuring a processor of a minimal logic gate that implements the same function and performance. A method of upgrading the performance by optimizing the number of semiconductors while maintaining the computational performance of the structure of the processor is devised. The present invention relates to a non-operational instruction set computer (NOISC, an operand-less instruction set computer).

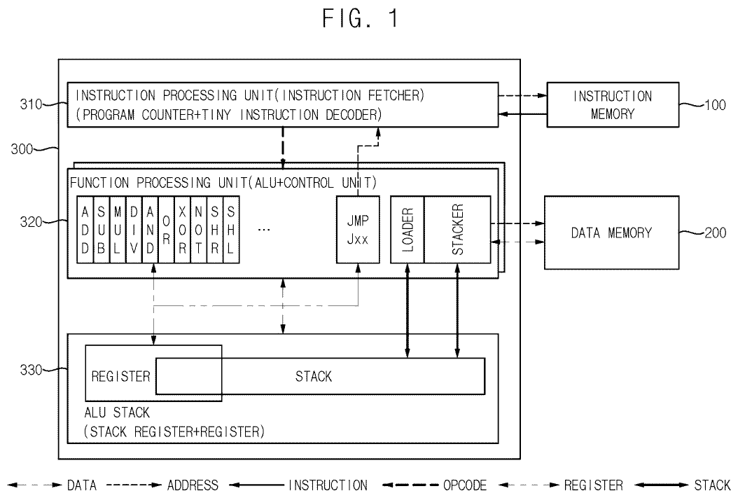

FIG. 1 is a block diagram explaining an operand-less instruction set architecture-based computer according to an exemplary embodiment of the present invention.

Referring to FIG. 1, an operand-less instruction set architecture-based computer according to an embodiment of the present invention includes an instruction memory 100, a data memory 200, and a processor 300.

The instruction memory 100 stores an instruction of a program, for example, a code to be executed by the processor 300. The instruction may include an operational code (opcode) indicating the type of operation and an operation for designating data to be processed or an address at which the data is stored.

The data memory 200 stores data necessary during program execution, for example, information such as variables, arrangements, objects, and the like.

The processor 300 includes an instruction processing unit (IPU) 310, a functional processing unit (FPU) 320 connected to the instruction processing unit 310, a stacked register (SR) 330 connected to the functional processing unit 320, and reads the instruction of the program from the instruction memory 100 and receives and transmits data from the data memory 200. The processor 300 uses an address when reading the instruction from the instruction memory 100. The processor 300 uses an address when reading and writing data from the data memory 200, and access to the memory is performed according to the size and format of the data.

The instruction processing unit 310 processes the instruction of a program. The instruction processing unit 310 reads the instruction from the instruction memory, interprets and executes the instruction. That is, since the instruction processing unit 310 utilizes the register shared with the FPU stack in the ALU as a register of the computing device, the number of instructions is greatly reduced and the operand is eliminated, and functions such as a decoder may be extremely simplified. Thus, even if the instruction processing unit 310 is integrated, the complexity of the structure is not high. Therefore, performance degradation due to the solution of complexity may also be avoided.

The functional processing unit 320 performs various arithmetic functions (arithmetic, logic, etc.) for data processing and receives data from the data memory. That is, the functional processing unit 320 includes a control function and an ALU. That is, the functional processing unit 320 is modularized for all functions, thereby simplifying and standardizing, and the structure thereof may be extremely simplified. Furthermore, it is easy to expand the structure through the addition of a module. The functions of the functional processing unit 320 include a function of performing an arithmetic function, a function of receiving and receiving data from a data memory, a function related to a branch, and the like. Each function has a different role to perform, but each function is operated equally in the instruction processing unit 310.

Since the functional processing unit 320 also has the effect of separating the instruction processing by the instruction processing unit 310 and the data processing by the functional processing unit 320 through the stacked register 330, it is easy to advance the processor 300 by structure, standardization, and simplification. In the ALU, the FPU stack is accessed as a register, and the control unit accesses the data stack to ensure consistency, thus simplifying the overall structure.

The stacked register 330 separates instruction processing by the instruction processing unit 310 from data processing by the functional processing unit 320.

As described above, the instruction processing unit 310 may use a register connected to an arithmetic logic unit (ALU) to reduce a complexity such as an operand and minimize the number of instructions, thereby simplifying functions such as a decoder. Accordingly, the complexity of the overall structure may be reduced and performance degradation may be prevented.

In addition, because the functional processing unit 320 is modularized, it may be easily standardized for each function, and the structure may be easily expanded with additional modules. Each function performs a different function but operates in the same manner in cooperation with the instruction processing unit 310. Because of this modularization, the entire structure may be greatly simplified.

In addition, the stacked register 330 establishes a clear boundary between the instruction processed by the instruction processing unit 310 and the data processed by the functional processing unit 320, thereby facilitating the structure, standardization, and simplification of the processor. This improves the consistency and simplicity of the entire system.

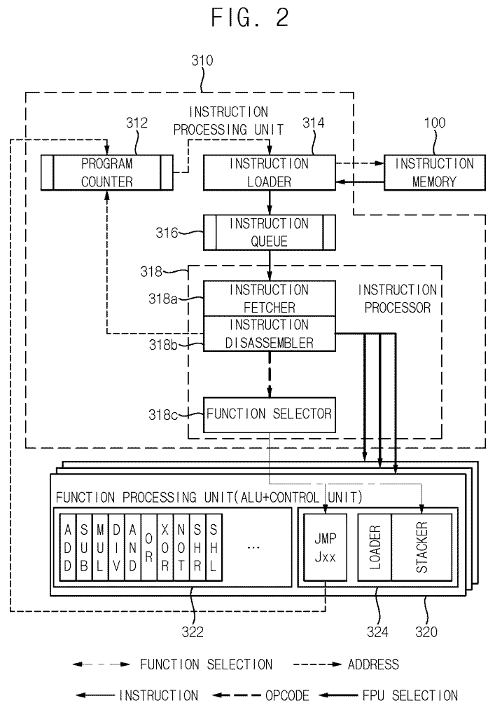

FIG. 2 is a diagram explaining a structure of the instruction processing unit shown in FIG. 1.

Referring to FIG. 1 and FIG. 2, the instruction processing unit 310 includes a program counter (PC) 312, an instruction loader 314, an instruction queue (IQ) 316, and an instruction processor 318.

The program counter 312 stores a memory address of an instruction currently being executed. The program counter 312 controls a flow of a program and designates an address of an instruction to be executed next. The program counter 312 increases the value of the program counter 312 whenever the instruction is executed, indicating the next instruction.

The instruction loader 314 reads the instruction from the instruction memory 100 and stores the instruction in the instruction queue 316. This process is a step of preparing the instruction to be used by the functional processing unit 320.

The instruction queue 316 serves as a buffer for storing instructions loaded by the instruction loader 314. The instruction is operated in units of bytes, and when the contents of the queue are exhausted, the instruction processor 318 loads a new instruction into the instruction queue 316. The instruction queue 316 supports continuous instruction processing and makes the instruction quickly accessible when needed.

The instruction processor 318 includes an instruction fetcher 318a, an instruction disassembler 318b, and a function selector 318c.

Specifically, the instruction fetcher 318a is for reading an instruction from the instruction queue 316 and providing the instruction to the functional processing unit 320. When the contents of the instruction queue 316 are exhausted, the instruction fetcher 318a loads a new instruction into the instruction queue 316 according to the address of the program counter 312. The instruction fetcher 318a updates the address of the program counter 312 according to a change in the control flow of the JMP instruction or the like, and readjusts the contents of the queue.

The instruction disassembler 318b interprets the instruction and converts the instruction into an executable form. The instruction disassembler 318b processes an instruction without an operand as 1 byte and configures the entire instruction including an additional byte, for example 3 to 4 bytes, into the instruction with the operand. The instruction disassembler 318b extracts a control signal opcode and a functional processing unit selector from the first byte to provide unique processing information.

The function selector 318c operates a function module in the functional processing unit 320. That is, the function selector 318c determines which function module to activate based on the control signal of the instruction. According to the type of instruction, an appropriate unit is selected from a plurality of functional processing units 320 and executed.

Accordingly, various functions such as integer operation, floating point operation, vector operation, tensor operation, branch processing, and the like may be efficiently performed.

In operation, since the instruction is configured in byte units, the instruction queue 316 is operated in byte units. When the most significant bit of the instruction (i.e., a bit indicating that the instruction has no operand) is set, the program counter 312 corresponding to one byte is incremented, and when the most significant bit of the instruction is not set, the instruction byte and the instruction of 4 bytes are added.

The instruction disassembler 318b may correspond to an instruction decoder. The instruction disassembler 318b receives an instruction and generates a control signal opcode for the instruction in a simple and separate form, and there is basically no operand in the instruction, so that the instruction decoding process is simple and fast. The instruction disassembler 318b adopts the functions of the decoder to simplify the structure.

When the contents of the instruction queue 316 are exhausted, the instruction fetch 318a puts the instruction of the corresponding address into the instruction queue 316. When the contents of the program counter 312 are changed due to a JMP function or the like, the instruction fetch 318a deletes the contents of the instruction queue 316 and fetches the instruction of the address of the program counter 312 to the instruction queue 316.

In the present embodiment, the instruction disassembler 318b may select a unit to be executed from among a plurality of functional processing units 320. As a result, a plurality of functional processing units 320 may be configured according to the type of instruction.

In the present embodiment, the functional processing unit 320 may be divided into a plurality of units according to the characteristics of the data to be processed. Various extensions and transformations are easily possible according to the type of data processed by the functional processing unit 320. A separate functional processing unit 320 may be configured between instructions sharing the stack of the functional processing unit 320 having a specific structure, and a functional processing unit 320 may be configured by simplification. Accordingly, the functional scalability of the processor 300 is very large.

Since the instruction set in the present invention is simple and a separate conversion from the instruction to the control signal opcode is unnecessary, the instruction fetch mainly serves as a branch of the instruction, unlike the decoder of the existing computer. That is, the instruction fetch plays an important role of the control unit by taking advantage of this simplicity. The existing computer architecture is composed of an ALU that processes data and a control unit that controls the whole, and in the present invention, the structure of the computer is divided into an instruction processing unit and a functional processing unit to improve performance.

In the present embodiment, since the instruction processing unit 310 uses the register shared with the FPU stack in the ALU as a register of the computing device, the number of instructions is greatly reduced and the operand is eliminated, and functions such as the instruction fetcher 318a and the decoder may be extremely simplified. Even if this is integrated, the complexity of the structure is not high. Therefore, performance degradation may be avoided by solving the complexity. A function for converting the instruction queue 316 into a separate opcode is not required.

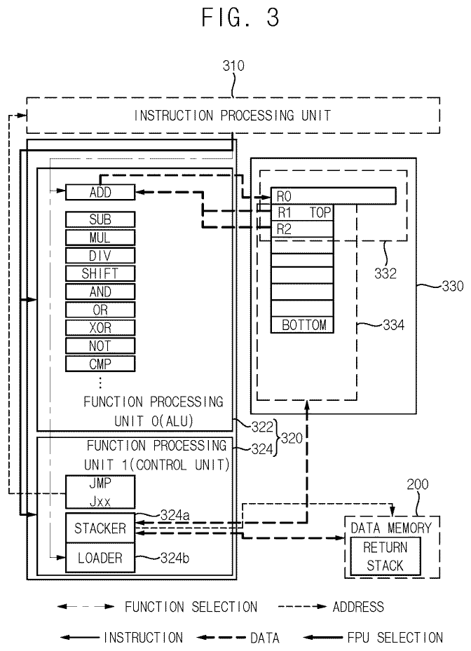

FIG. 3 is a diagram explaining a structure of the functional processing unit shown in FIG. 1 and FIG. 2.

Referring to FIG. 1 to FIG. 3, the functional processing unit 320 includes a first functional processing module 322 corresponding to an arithmetic logic operation device (ALU) having an arithmetic function similar to a general purpose computer, and a second functional processing module 324 corresponding to a control unit having a control function.

The functional processing unit 320 uses stacked registers instead of typical addressable registers. Of all the functional units, ALU-related functions use the top two stacks of the FPU stack 334. When an operation or function is completed, the results are placed on the lower stack and the top stack value is discarded. There is a separate register for storing the results of intermediate operations, and the separate register is sized to accommodate the progress of a multiplication operation.

A POP instruction or a PUSH instruction that brings data from the data memory 200 into the processor 300, for example, has the address of the data in memory as its operand. In order to maximize convenience, an immediate value is also accepted as an operand.

A Jump (i.e., JMP and Jxx) instruction, which is a branch instruction associated with the CMP instruction, has address information as an operand in the instruction. The operand is stored in a reference register and, when executed, is used as an address of the instruction memory 100.

Functions related to a control unit also utilize the FPU stack 334, and functions related to branch or reception and transmission of data additionally utilize address data included in an instruction.

The stacker 324a individually receives and transmits data of the data memory 200 to the FPU stack 334 by using the address information in the instruction, and the loader 324b collectively receives and transmits the address information in the instruction to the FPU stack 334. Here, the term “receiving and transmitting” means supporting or performing a certain task or service.

The operation units corresponding to the ALU and the control units corresponding to operations like Jump, Push, and Pop are treated with the same operational mechanism. In other words, while the ALU and the control unit perform their respective roles, instruction processing and operations operate within them according to the same method or principle.

The first functional processing module 322 operates the ALU register 332, and the second functional processing module 324 operates the FPU stack 334. That is, in order to perform a specific function or task, the first functional processing module 322 performs processing such as reading, writing and correcting data on the ALU register 332 using an arithmetic logic operation instruction such as ADD, SUB, MUL, DIV, Shift, and AND, and the second functional processing module 324 performs processing such as reading, writing and correcting data on the FPU stack 334. By synchronizing the ALU register 332 with the FPU stack 334, the structure of the functional processing unit 320 may be simplified.

In the present exemplary embodiment, the FPU stack 334 and the return stack (disposed in the memory) are used separately. The FPU stack 334 stores data required for an operation, and the return stack stores a return address corresponding to a function call. The return stack stores information related to an execution state of a called function when the function is called, and when the function is terminated, the return address information is used to return to the called location.

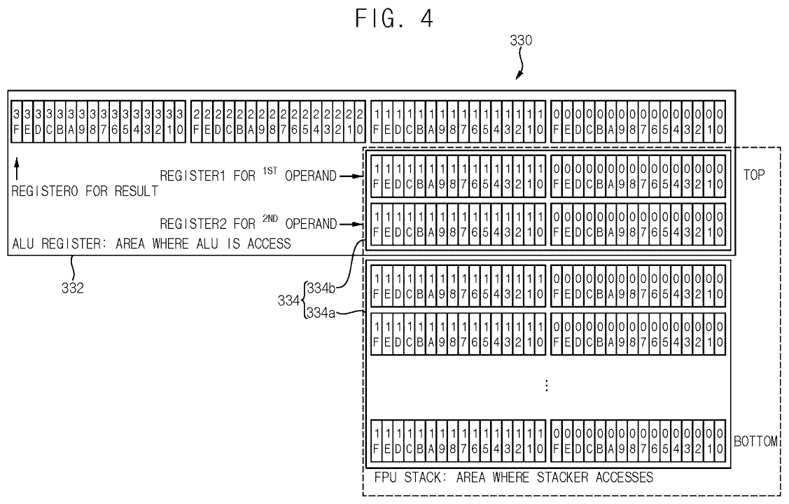

FIG. 4 is a diagram explaining a structure of a stacked register 330 illustrated in FIG. 3. In particular, the stacked register 330 for 32-bit integer processing is illustrated.

Referring to FIG. 3 and FIG. 4, the stacked register 330 includes an ALU register 332 accessed by the first functional processing module 322 and an FPU stack 334 accessed by the stacker 324a of the second functional processing module 324.

The FPU stack 334 includes a register stack 334a accessed by the stacker 324a and an operation-only register 334b operated by the ALU.

The register stack 334a has a shape for receiving the operand. The register stack 334a is a first-in, first-out (FIFO) data device and has a reasonable depth. The register stack 334a can take the form of a 32-bit or 64-bit floating point number, a 16-bit, 32-bit or 64-bit integer or a whole number, as required, and has extended data formats to handle a variety of data. The register stack 334a is operated by a PUSH instruction and a POP instruction and receives data from the data memory 200. Additional functions may be added to the register stack 334a as required.

The operation-only register 334b includes a first direct access register (Register1) R1 that stores a first operand as input data, a second direct access register (Register2) R2 that stores a second operand as input data, and a result storage register (Register0) R0 that stores the result of the operation. The data is received and transmitted via the stacker 324a, wherein the first direct access register R1 is synchronized to the top of the register stack 334a and the second direct access register R2 is synchronized or co-located with the next top of the register stack 334a. The result storage register R0 holds the result of the operation after the operation is completed, and places the value at the top of the register stack 334a. In this case, depending on the characteristics of the operation, the top of the register stack 334a is pre-authorized for output. That is, before executing a particular operation, be prepared to output the highest data in the register stack 334a in advance, depending on the characteristics of the operation. For example, taking data out of the stack to perform arithmetic operations, or pre-reading data for memory operations. This prepares the operation to flow normally without interruption.

Specifically, the result storage register R0 stores the result value of the operation. That is, the result of the operation is finally stored in the result storage register R0. A size of the result storage register R0 is set to 64 bits, which is a size capable of accommodating 64 bits of a multiplication result or 32 bits of an addition result. After the result of the operation is stored in the result storage register R0, the lower 32 bits are transferred to the accessible area of the stack. In the present embodiment, the result storage register R0 stores the execution result of the instruction executed by the processor, which may include a 32-bit or 64-bit register, but the present invention is not limited thereto. In the present embodiment, the result storage register R0 may store integer data or floating point data.

The first direct access register R1 is an uppermost register of the stack and is referred to in an operation instruction. Specifically, the value of the first direct access register R1 is required when performing an operation. Since it is the uppermost stack register 330, it is a value located at the top of the current stack.

The second direct access register R2 is a next-level register of the stack and is referred to in the operation instruction together with the first direct access register R1. Specifically, the second direct access register R2 is located directly below the first direct access register R1. When performing an operation, a result is generated using the values of the first direct access register R1 and the second direct access register R2.

Thus, the result storage register R0 serves as a final storage for storing the operation result, and the first direct access register R1 and the second direct access register R2 serve to provide operands required to perform the operation. The first direct access register R1 is an uppermost register of the stack, and the second direct access register R2 is a next upper register located directly below the uppermost register of the stack.

The result storage register R0 that stores a result value and a stack of n-depths are configured, wherein the topmost portion of the stack is shared with the first direct access register R1, and the second topmost portion of the stack is shared with the second direct access register R2. The register is accessible only inside the FPU of the operation function, and exchanges information with the memory through the area of the FPU stack 334.

A result of the result storage register R0 is generated through the first direct access register R1 and the second direct access register R2 referred to by the operation instruction. Only the lower 32 bits of the result are moved to the area accessed by the stacker 324a. A 64-bit result is generated for 32-bit multiplication, and a 33-bit result is generated for 32-bit addition. The size of the result storage register R0 is preferably 64 bits.

When the size of the FPU stack 334 is insufficient due to the complicated operation, the entire FPU stack 334 may have to be backed up. When such a backup is performed as a separate software program, performance degradation may be significant. When the size of the FPU stack 334 is increased, the number of logic gates may increase. Therefore, a depth of the stack should be minimized within an appropriate range. In order to minimize the depth of the stack, an instruction for supplying and receiving the FPU stack 334 to the memory as a whole is required. It is possible to determine an SBACKUP instruction that moves all the contents of the FPU stack 334 into the memory, and a RESTORE instruction that moves the contents of the FPU stack 334 stored in the memory back to the FPU stack 334. Accordingly, it is possible to overcome problems of limitation and performance degradation according to the size of the stack.

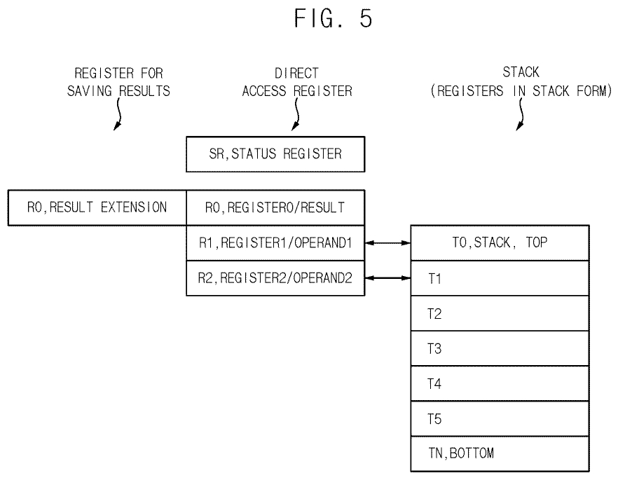

FIG. 5 is a diagram explaining an FPU stack structure as an example.

Referring to FIG. 5, the FPU stack 334 has a stacked registers for dual access structure for direct access to the stack. The FPU stack 334 is composed of registers in the form of a stack and direct access registers.

The T0 (top) of the stack and the first direct access register R1 are synchronized, the T1 (top-1) of the stack and the second direct access register R2 are synchronized, and a result storage register R0 for storing the result is separately configured.

In the FPU stack 334, two registers are completely separated in terms of access, but physically the first direct access register R1 and the stack T0 are the same, and the second direct access register R2 and the stack T1 are the same.

A method of synchronizing between the first direct access register R1 and the stack T0 and a method of synchronizing between the second direct access register R2 and the stack T1 vary, such as a method of operating the corresponding register as a dual port and real-time milling.

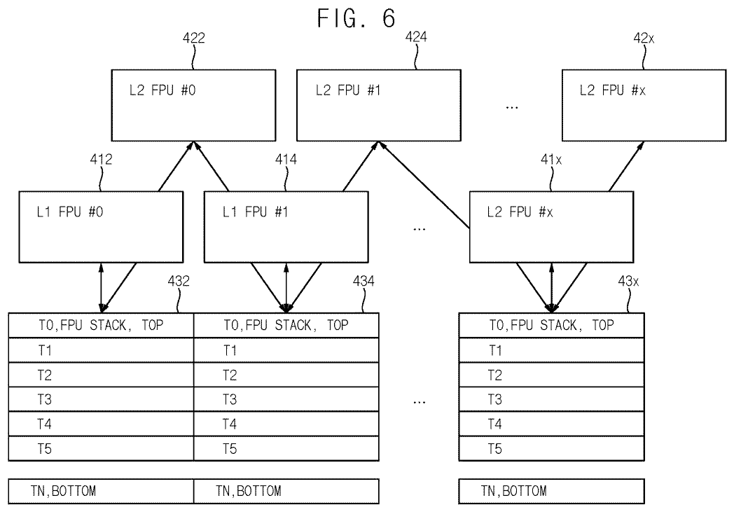

FIG. 6 is a diagram explaining an example of applying multiple functional processing units (FPU).

Referring to FIG. 6, a first functional group corresponding to a first dimension includes a plurality of functional processing units 412, 414, . . . , 41X, and a second functional group corresponding to a second dimension includes a plurality of functional processing units 422, 424, . . . , 42X. The first functional group and the second functional group include a plurality of stack registers 432, 434, . . . , 43X.

Meanwhile, in the case of AI operations such as 4-bit, 8-bit, and 16-bit, a method in which one functional processing unit (FPU) manipulates multiple stacks is also possible. At this time, it is advantageous to expand the performance by upgrading the function or simplifying the structure of the existing NPU or PIM/PNM.

In this way, when multiple functional processing units (FPUs) are applied, a dedicated processor that performs various operations such as advanced tensor operations required in the AI field may be configured. This is also very useful for vector operations and requires much less resources than existing methods.

Here, the tensor is a multidimensional array, which is the basic unit of data representation in machine learning. For example, images are represented by three-dimensional tensors (height, width, and color channels). AI models perform complex tensor operations that include matrix multiplication, convolution, and activation functions, which can be simultaneously processed through multi-functional processing units, speeding up learning.

In addition, vector operation is a method of processing multiple data elements simultaneously. When there are multiple functional processing units (FPUs), parallel processing of the operation becomes possible. This is very useful for vector internalization in AI algorithms, vector conversion, etc. In addition, distributed processing of the operation by multiple FPUs may maintain high performance while consuming far fewer resources than traditional CPU-based methods. Therefore, resource efficiency may be increased.

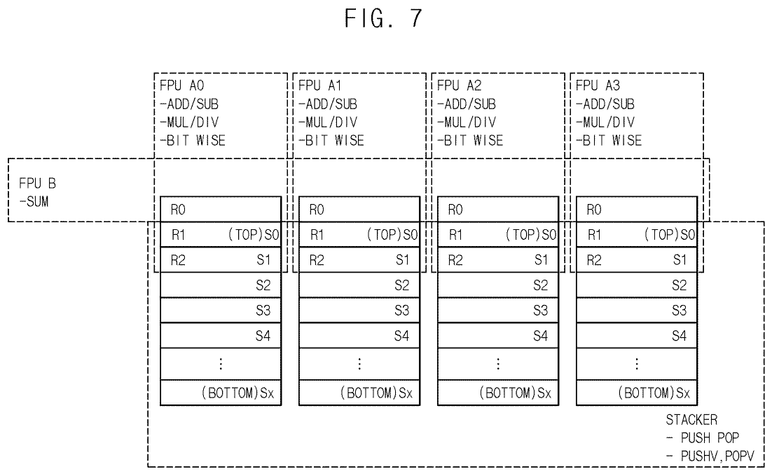

As described in FIG. 6, simple function grouping such as L1 FPU and L2 FPU is possible for simple functional processing units by dimension. However, an entirely different dimension of FPU multiplexing is possible, as shown in FIG. 7 below. Of course, even in the existing technology, it is possible to configure the ALU to be used two-dimensionally, but there is no commercial possibility due to too high complexity of the circuit configuration. In contrast, in the present invention, it is easy to serialize the FPU and the FPU stack 334 and expand the multidimension of the FPU function.

FIG. 7 is a diagram explaining an application of a multiple and multi-dimensional functional processing unit (FPU).

Referring to FIG. 7, a structure of the FPU stack may be expanded in two dimensions to configure multiple FPUs having different functions. That is, functionality may be maximized by accessing the entire FPU stack group as in FPU B.

In general, in order to perform scalar processing and vector processing, two types of ALUs must have two types of registers together, namely, a general (scalar) register and a vector register. A general ALU operates the general register in a general operation, and a vector ALU operates the vector register in a vector operation.

On the other hand, in the present embodiment, it is possible to build a multi-set FPU stack operated by an FPU stack stacker, and it is possible to access the multi-set FPU stack by configuring different FPUs for different purposes. Accordingly, vector processing is easily implemented. In particular, by configuring separate instructions such as PUSH-PUSHV, POP-POPV, etc., which accommodate scalar data and vector data in the stacker (it is reasonable to consider the stacker as a kind of FPU), vector data and scalar data can be operated in one FPU stack or FPU stack group.

In addition to vector processing, the function of Tensor processing as shown in FPU B may be easily implemented. Not only may the result calculated by the FPU A group be summed in the FPU B group, but it is easy to implement various functions. An optimal tensor processing function may be achieved by expanding the functionality of the FPU, such as the FPU B group, and optimization may be achieved with relative ease.

Hereinafter, an instruction set architecture (ISA) used in the present invention will be described.

In the present embodiment, there is an operand only in the instructions for receiving and transmitting data, and there is no operand in the other instructions. Instructions without an operand-less instruction are operand-less instructions. Each instruction performs an operation based on the FPU stack and performs an operation using the uppermost value of the stack. The operand corresponding to the address value is applied only when the memory needs to be accessed, such as when data in the data memory has to be referred. An instruction set is configured so that the C-language may be operated without disruption. Instructions required implementing the C-language in an existing general processor such as CISC and RISC are as follows.

### <Data Transfer Instructions>

LOAD/LD: Loads data from memory into registers.
STORE/ST: Stores the data in the register in memory.
MOVE/MOV: Move data from one register to another.
PUSH: Store data in a stack.
POP: Read data from the stack.

### <Arithmetic Instructions>

ADD: Add the values in both registers.
SUB: Subtract the values of both registers.
MUL: Multiply the values of the two registers.
DIV: Divide the values of the two registers.
INCREMENT/INC: Increase the value of the register by 1.
DECREMENT/DEC: Reduce the value of the register by 1.
NEGATE/NEG: Invert the sign of the register.

### <Logical Instructions>

AND: Performs a bitwise logical AND operation of two registers.
OR: Performs a bitwise logical OR operation on the two registers.
XOR: Performs bitwise logical XOR operations on both registers.
NOT: Performs bitwise logical NOT operations on the register.
SHIFT LEFT/SH: Shift the bits in the register to the left.
SHIFT RIGHT/SHR: Shift the bits in the register to the right.

### <Control Flow Instructions>

JUMP/JMP: Jump unconditionally to a specific address.
JUMP IF ZERO/JZ: Jump to a specific address if the register value is 0.
JUMP IF NOT ZERO/JNZ: Jump to a specific address if the register value is not zero.
JUMP IF EQUAL/JE: Jump to a specific address if both registers are equal.
JUMP IF NOT EQUAL/JNE: If the values of the two registers are different, jump to a specific address.
CALL: Calls the subroutine (function).
RETURN/RET: Returns from the subroutine (function).
LOOP: Repeat until counter is zero.

### <Comparison Instructions>

COMPARE/CMP: Compare the values of the two registers.
TEST: Test specific bit patterns.

### <System Instructions>

NO OPERATION/NOP: Do nothing and move on to the next instruction.
INTERRUPT/INT: Generates a software interrupt.
RETURN FROM INTERRUPT/RETI: Return after interrupt processing.
HALT: Stops the processor.

### <Stack Instructions: Provides Functional Support for Function Call>

PUSH: Push data to the stack.
POP: Pop data onto the stack.
CALL: Store the current address on the stack and jump to a specific address to call the subroutine.
RETURN/RET: Store the old address on the stack and jump to that address to return from the subroutine.

### <Bit Manipulation Instructions>

SET BIT/SETB: Sets a specified bit in a register or memory location.
CLEAR BIT/CLRB: Clears a specified bit in a register or memory location.
TOGGLE BIT/TGLB: Toggles a specified bit in a register or memory location.

Even though the processor of the present invention includes all of the functions, the number of instructions is small and thus can be processed as a single byte. Since some instructions require an operand, they have a structure as shown in the following example.

Operand-less instructions are shown in Table 1 below. Table 1 shows a one-byte instruction.

TABLE 1

| Byte 0 | |
|---|---|
| 76 | 543210 |
| FPU | Opcode |

Referring to Table 1, an instruction without an operand is set to 1 byte, an opcode is assigned to the lowest 6 bits of byte 0, and an FPU is assigned to the highest 2 bits of byte 0.

Instructions with Operand are shown in Table 2 below. Table 2 shows a 5-byte instruction.

TABLE 2

Byte 4

| | | | | | |
|---|---|---|---|---|---|
| 76 | 543210 | Byte 3 | Byte 2 | Byte 1 | Byte 0 |

| | | |
|---|---|---|
| FPU | Opcode | Address |
| | | 32 bit Immediate Value |

Referring to Table 2, an instruction with operand is set to 5 bytes, and an address and a 32-bit immediate value are assigned to the lowest byte 0 through byte 3. In addition, an opcode is assigned to the lowest 6 bits of the highest byte 4, and the highest 2 bits of byte 4 are assigned to an FPU.

In this way, the instruction consists of one byte. 0 to 2 bits of the instruction are used as an identification area for selecting the functional processing unit 310, and the remaining bits correspond to the function.

### Instruction Set Architecture Example

The bit composition of the instruction is shown in Table 3 below.

TABLE 3

| Bit | Function | Note |
|---|---|---|
| 7 | Whether it is operand or not | Use these two bits to select the |
| | (0: Non-operand, 1: with Operand) | value (signal) to select the FPU. |
| 6 | Whether it is calculated or not | |
| | (0: ALU, 1: Control) | |
| 5 | OP5 | Each of these six bits |
| 4 | OP4 | corresponds to a maximum of 64 |
| 3 | OP3 | instructions. |
| 2 | OP2 | |
| 1 | OP1 | |
| 0 | OP0 | |

Referring to Table 3, when the functional processing unit 310 is composed of ‘FPU00: Operation without Operand’, ‘FPU01: Control without Operand’, ‘FPU10: Branch with Operand’, and ‘FPU11: Data receiving and transmitting with Operand’, it is an example of an instruction set.

The instruction configuration for each function is as follows.

### <Arithmetic >

### (Arithmetic Instructions)

ADD, SUB, INC, DEC, NEG, MUL, DIV, INV

### (Logical Instructions)

AND, OR, XOR, NOT

### (Bit Manipulation Instructions)

SHL, SHR

### <Branch>

JMP, JZ, JNZ, JE, JNE, JG, JGE, JL, JLE, CMP

### <Data Provisioning>

PUSH, POP, CALL, RET

### <Control>

NOP, HALT

The above-described instructions may be categorized based on the presence or absence of operands.

The construction of the instruction according to the instruction mechanism is as follows.

<Instructions without Operands>
Manipulating (performing operations on) the FPU stack
ADD, SUB, INC, DEC, NEG, MUL, DIV, INV, AND, OR, XOR, NOT, SHL, SHR
Manipulating other registers-performing control functions
CMP, NOP, HALT, RET
   <Instructions with Operands>
Transferring data to the FPU stack
PUSH, POP, LOAD, RESTORE
Jumping (manipulating the program counter)
CALL, JMP, JZ, JNZ, JE, JNE, JL, JG, JLE, JGE

The above instructions are sufficient to implement the C-language. To illustrate this visually, the following example is provided.

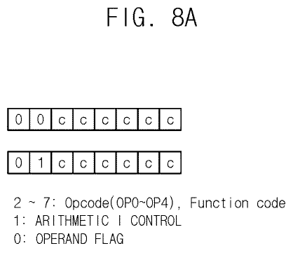

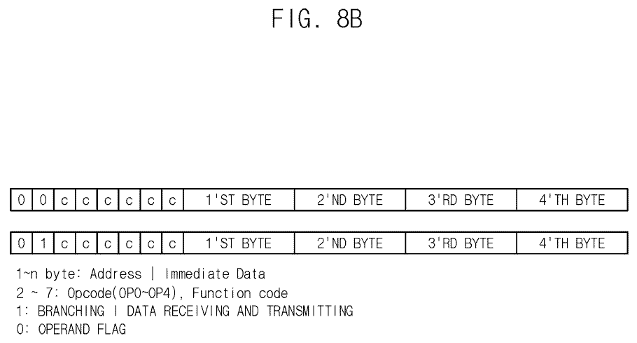

FIG. 8A and FIG. 8B are diagrams explaining a detailed instruction form. In particular, FIG. 8A shows a 1-byte instruction of instruction processing without an operand, and FIG. 8B shows a 5-byte instruction of instruction processing with an operand.

Referring to FIG. 8A, a first direct access register R1 and a second direct access register R2 each store 1 byte of instructions. That is, “00CCCCCC” is stored in the first direct access register R1 and “01CCCCCC” is stored in the second direct access register R2. Here, bits 2 to 7 are assigned to the opcode and function code for OP0 to OP4, bit 1 is assigned to the operation and control flag, and bit 0 is assigned to the operand flag.

The Opcode is delivered to the corresponding instruction processing unit 310 among the four processing units. The program counter is incremented by 1.

Referring to FIG. 8A, instructions of 5 bytes are stored in each of the first direct access register R1 and the second direct access register R2. That is, “10cccc” is stored in the most significant 1 byte of the first direct access register R1, and “11CCCC” is stored in the most significant 1 byte of the second direct access register R2. In addition, address values or immediate values are stored in three bytes of each of the first direct access register R1 and the second direct access register R2.

In this case, in the top 1 byte of each of the first direct access register R1 and the second direct access register R2, OPcode and function code of OP0 to OP4 are allocated to 2 to 7 bits, branch and control flag are assigned to 1 bit, and operand flag are assigned to 0 bits.

Opcode is transmitted to the corresponding instruction processing unit 310 among the four processing units. The program counter is incremented by 5.

An example of the instruction table may be configured based on the contents described in FIG. 8A and FIG. 8B.

Since the instruction is composed of 8 bits, a total of 256 instructions may be provided. However, in practice, only about 60 instructions are expected to be sufficient. As shown in the above description, if the upper bits (topmost bits 1 to 3) are set to a value for designating (selecting) a functional processing unit, a plurality of functional processing units may be configured according to the function to optimize efficiency and performance.

Instructions from 0x00 to 00xFF may be composed of four instruction sets corresponding to 0x00 to 0x3F, 0x40 to 0x7F, 0x80 to 0xbF, and 0xC0 to 0xFF. Each of the four instruction sets selects a separate functional processing unit and calls its functions (functions, circuits), so that it may be structured in the entire circuit configuration.

That is, 256 numbers from 0x00 to 0xFF may consist of a first instruction set from 0x00 to 0x3F, a second instruction set from 0x40 to 0x7F, a third instruction set from 0x80 to 0xBF, and a fourth instruction set from 0xC0 to 0xFF. The instruction set for each range may contain different functions or commands. For example, the first instruction set may contain basic instructions, the second instruction set may contain moderate complexity, the third instruction set may contain advanced instructions, and the last fourth instruction set may contain special instructions.

### Example of the Instruction Table of the Present Invention

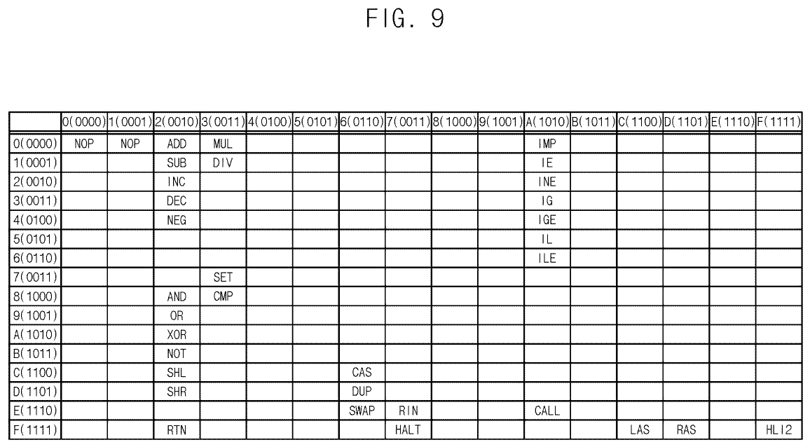

When presented as the mechanism for accommodating C language in the present invention, it may be composed of the following instruction sets. The functions and instructions processed by the functional processing unit correspond on a 1:1. The instruction set may be exemplified as shown in the following FIG. 9.

FIG. 9 is a diagram explaining an instruction table.

A simplified decoder structure for minimizing the number of logic gates is formed by the method shown in FIG. 9. In particular, since the number of instructions is small, the execution of the instruction may be effectively performed even if the decoder is configured with a simple circuit. The decoder's role is to automatically execute classification according to the mechanism of the instruction through the top two bits. This may be implemented through the pursuit of simplification of decoding and is a different mechanism from existing processors.

Instructions have the following functions.

### <Stack Operation Instruction>

Stack operation instructions perform the function of transferring data from the data memory to the FPU stack or computational data from the FPU stack to the data memory.
PUSH [Addr]: Adds the data from the data memory to the FPU stack.
PUSHV [int4]: Adds a 32-bit data value to the FPU stack.
POP [Addr]: Moves and deletes the data from the FPU stack to the data memory.
LOAD [Addr]: Loads the data corresponding to a set of stack data from memory to the FPU stack.
RSTR [Addr]: Moves all data related to the FPU stack as a set to memory.
DUP: Copies the topmost value of the FPU stack and adds it back to the stack.
SWAP: Swaps the top two values of the FPU stack.
CAS: Clears all values from the FPU stack and resets the stack pointer.

Instructions without operands, such as PPN (delete the topmost value) and PSHN (insert a Null value), may be added.

### <Arithmetic Operation Instructions>

All arithmetic instructions target only the stack in the ALU, but the mechanism of operation thereof is the same as the register of the existing computer. That is, the register is operated as a register fixed to a result storage register R0, a first direct access register R1, and a second direct access register R2 on the ALU side, and data transmission and reception with the memory are performed by a stack operation instruction.

In ALU, an operation function such as ‘ADD’ operates as a mechanism for ‘ADDR0 R1 R2; R0=R1+R2’ of an existing computer.

ADD: Add the top two values of the FPU stack to store the result in the result register, delete the top two values, and input the values of the result register into the stack. The Pseudocode corresponding to the operating mechanism is as follows:

======================
pop Register1; <Top>
pop Register2; <Top-1>
Register0 <− Register1 + Register2
push Register0; <Top>
======================

The ADD operation circuit adds the top two values, T0 and T-1, of the stack and stores the sum in the next upper value, T-1, discarding the highest value, T0, from the stack. In other words, the top two values of the stack are combined into a single value, and the remaining values are removed.
SUB: (NEG+ADD) Replace the topmost value of the FPU stack with an inversion number, add the top two values, delete the top two values, and enter the value of the result register into the stack. In other words, change the next-highest stack value to an inversion number and add the topmost value.
NEG: Turn the highest value of the FPU stack into an inversion number, that is, a negative number is converted to a positive number, or a positive number is converted to a negative number.
INC: Increase the top value of the FPU stack by 1.
DEC: Reduce the top value of the FPU stack by 1.
MUL: Multiply the top two values of the FPU stack to store the result in the result register, delete the top two values, and input the value of the result register into the stack.
DIV: (INV+MUL) Change the top value of the FPU stack to the reciprocal and multiply the top two values to store the result in the result register, delete the top two values, and input the value of the result register into the stack. That is, the NEG operation is an operation of taking a reciprocal and storing the result of multiplying two values in the stack.
INV: Transform the uppermost value of the FPU stack into a reciprocal number.

That is, change the sign of the index part by dividing 1 by the corresponding value.

Substantially, the ALU may be constructed using only ADD and MUL.

### <Logical and Bitwise Operation Instructions>

AND: Performs a bitwise AND operation on the top two values of the FPU stack and stores the result in the stack.
OR: Performs a bitwise OR operation on the top two values of the FPU stack and stores the result in the stack.
XOR: Performs a bitwise XOR operation on the top two values of the FPU stack and stores the result in the stack.
NOT: Performs a bitwise NOT operation on the top value of the FPU stack and stores the result in the stack.
SHL: Shifts the second value of the FPU stack to the left by the number of positions specified by the top value.
SHR: Shifts the second value of the FPU stack to the right by the number of positions specified by the top value.

Bitwise operations perform operations on all bits. In the case of logical operations, only the least significant bit of the data is used.

### <Comparison and Conditional Branch Instructions>

Request addresses value as operand.
JMP [Addr]: Jumps to the address [Addr].
JE [Addr]: Jumps to [Addr] if the top value of the FPU stack is equal to the second value.
JNE [Addr]: Jumps to [Addr] if the top value of the FPU stack is not equal to the second value.
JG [Addr]: Jumps to [Addr] if the top value of the FPU stack is greater than the second value.
JGE [Addr]: Jumps to [Addr] if the top value of the FPU stack is greater than or equal to the second value.
JL [Addr]: Jumps to [Addr] if the top value of the FPU stack is less than the second value.
JLE [Addr]: Jumps to [Addr] if the top value of the FPU stack is less than or equal to the second value.
CALL [Addr]: Pushes the current program counter onto the memory stack and jumps to [Addr].
RTN: Pops the memory stack and sets the program counter to the popped value, effectively jumping to that address.

### <System Control Instructions>

NOP: Does not perform any operation.
HALT (Break): Resets the program counter and stops operation. It halts the program execution and keeps the processor in an idle state.
HLTA (Exit): Resets the instruction memory area and stops operation.
PAUSE: Stops program execution until a restart signal is received.

Since the computer structure of the present invention is significantly different from the existing computer technology, there are derived instructions in addition to the above-described instructions.

<Derived instructions>

JUMP <address> --> JMPD <immediate value>
PUSH <address> --> PSHV <immediate value>
POP <address> --> PPN
PUSH <address> --> PSP4/PSP2/PSP1 <address>
POP <address> --> POP4/POP2/POP1 <address>

In order to improve performance and function, various derived instructions are added within a range that does not significantly increase the complexity of the circuit.

The effects according to the present invention described above are summarized as follows.

(1) By configuring the registers used for operations in the ALU as stacks, the operand may be eliminated from most instructions. Since there is no operand in most instructions except for branching or data receiving and transmitting, a short instruction of less than 1 byte may be configured.

(2) Since there is no operand and the instruction is short, the control function for handling it may be simplified. Since simple instruction interpretation is possible without an operand, the execution speed is improved and the processing speed is increased. Since an instruction pipeline is not required for instruction processing, the structure is simple and easy to implement.

(3) It is possible to structure the instruction set by reconfiguring each instruction function or required resource. Accordingly, the instruction processing unit may be further simplified. Due to the structure and simplification described above, a small number of logic gates is required compared to existing CISC and RISC architecture processors, and the number of logic gates is minimized. The structure is further simplified by a simple instruction set and stack-based operation. By reducing the number of logic gates, power consumption and heat generation are reduced. As a result, power efficiency increases. Since the amount of heat generated is reduced, the life of the semiconductor is extended and the management of heat generation is simplified.

(4) Due to the small number of logic gates, the size of the chip may be reduced, enabling miniaturization. In addition, more processors may be integrated on the same die. This may replace efforts to reduce the line width of the semiconductor. This may lead to a dramatic reduction in production costs because low-cost manufacturing technologies may be used. In addition, since only a small number of transistors are required to implement a unit of performance, a double reduction in production costs is possible.

(5) Compared to existing processors, the number of logic gates required to ensure arbitrary functions and performance is extremely small, so there is an overwhelming advantage in configuring PIM or PNM. It is also advantageous to configure a collective operation device such as vector operation or tensor operation. It is possible to upgrade the structure of PIM/PNM.

(6) Since the number of logic gates is required to be small, the cross sectional area of the circuit configuration is smaller than that of existing processor technology, even if the insulating part is reinforced in the process of manufacturing the fine line-width semiconductor. As a result, leakage current may be suppressed to configure an innovative low-power processor.

(7) All functions, such as operation and control, may be appropriately modularized through standardization and simplification, so that the configuration of the entire processor may be structured and optimized. It is advantageous in terms of cost compared to existing technology by configuring a processor core and integrating multiple processors.

(8) Stack-based processors may easily apply post-ordering to instructions. This makes compiler development easy and efficient. It is optimized for these needs.

Having described exemplary embodiments of the present invention, it is further noted that it is readily apparent to those of reasonable skill in the art that various modifications may be made without departing from the spirit and scope of the invention which is defined by the metes and bounds of the appended claims.

What is claimed is:

1. An operand-less instruction set architecture-based processor comprising:
an instruction processing unit configured to process program instructions that do not require operands, except for instructions related to receiving and transmitting data;
one or more functional processing units configured to perform a plurality of functions for data processing; and
a stacked register configured to separate instruction processing by the instruction processing unit from data processing by the functional processing unit.

2. The operand-less instruction set architecture-based processor of claim 1, wherein the instruction processing unit comprises:
a program counter configured to store the memory address of the currently executing instruction, control the flow of the program, specify the address of the next instruction to execute, and increment the program counter value each time an instruction is executed to indicate the next instruction;
an instruction loader configured to read instructions from external instruction memory;
an instruction queue configured to store instructions loaded by the instruction loader, support continuous instruction processing, and provide quick access to instructions when needed; and
an instruction processor configured to be respectively connected to the program counter, the instruction queue, and the functional processing unit.

3. The operand-less instruction set architecture-based processor of claim 2, wherein the program counter tracks the address of the next instruction by incrementing the counter based on the contents of the instruction queue.

4. The operand-less instruction set architecture-based processor of claim 2, wherein the instruction queue operates in units of bytes, and the instruction consists of 1 byte when there is no operand and 3 to 4 bytes when there is an operand to store the instruction.

5. The operand-less instruction set architecture-based processor of claim 2, wherein the instruction processor comprises:
an instruction fetcher configured to read instructions from the instruction queue and provide them to the functional processing unit;
an instruction disassembler configured to interpret instructions and convert them into executable form; and
a function selector configured to activate function modules within the functional processing unit.

6. The operand-less instruction set architecture-based processor of claim 5, wherein the instruction disassembler processes instructions without an operand as a single byte and includes additional bytes in instructions with an operand to form a complete instruction.

7. The operand-less instruction set architecture-based processor of claim 1, wherein the functional processing unit comprises:
a first functional processing module corresponding to an arithmetic logic unit (ALU) having an arithmetic function; and
a second functional processing module corresponding to a control unit having a control function.

8. The operand-less instruction set architecture-based processor of claim 7, wherein the stacked register comprises:
an ALU register accessed by the first functional processing module; and
an FPU stack accessed by the stacker of the second functional processing module.

9. The operand-less instruction set architecture-based processor of claim 8, wherein the FPU stack comprises:
a register stack accessed by a stacker; and
an operation-only register operated by an ALU.

10. The operand-less instruction set architecture-based processor of claim 9, wherein the operation-only register comprises:
a first direct access register that stores a first operand as input data;
a second direct access register that stores a second operand as input data; and
a result storage register that stores the result of an operation.

11. The operand-less instruction set architecture-based processor of claim 10, wherein the first direct access register is synchronized with, or identical to, the top of the register stack, and the second direct access register is synchronized with, or identical to, the next top of the register stack.

12. The operand-less instruction set architecture-based processor of claim 10, wherein the result storage register places the result value at the top of the register stack after the calculation operation is completed.

13. An operand-less instruction set architecture-based computer comprising:
an instruction memory configured to store the instructions of the program;
a data memory configured to store data necessary for the execution of the program; and
a processor configured to read the program instructions from the instruction memory and to receive and transmit data from the data memory, wherein the processor comprises:
an instruction processing unit configured to process program instructions, but having no operand other than instructions for receiving and transmitting data;
one or more functional processing units configured to perform a plurality of functions for data processing; and
a stacked register configured to separate instruction processing by the instruction processing unit from data processing by the functional processing unit.

14. The operand-less instruction set architecture-based computer of claim 13, wherein the instruction processing unit comprises:
a program counter configured to store the memory address of the currently executing instruction, control the flow of the program, specify the address of the next instruction to execute, and increment the program counter value each time an instruction is executed to indicate the next instruction;
an instruction loader configured to read instructions from external instruction memory;
an instruction queue configured to store instructions loaded by the instruction loader, support continuous instruction processing, and provide quick access to instructions when needed; and
an instruction processor configured to be respectively connected to the program counter, the instruction queue, and the functional processing unit.

15. The operand-less instruction set architecture-based computer of claim 14, wherein the program counter tracks the address of the next instruction by incrementing the counter based on the contents of the instruction queue.

16. The operand-less instruction set architecture-based computer of claim 14, wherein the instruction queue operates in units of bytes, and the instruction consists of 1 byte when there is no operand and 3 to 4 bytes when there is an operand to store the instruction.

17. The operand-less instruction set architecture-based computer of claim 14, wherein the instruction processor comprises:
an instruction fetcher configured to read instructions from the instruction queue and provide them to the functional processing unit;
an instruction disassembler configured to interpret instructions and convert them into executable form; and
a function selector configured to activate function modules within the functional processing unit.

18. The operand-less instruction set architecture-based computer of claim 13, wherein the functional processing unit comprises:
a first functional processing module corresponding to an arithmetic logic unit (ALU) having an arithmetic function; and
a second functional processing module corresponding to a control unit having a control function.

19. The operand-less instruction set architecture-based computer of claim 18, wherein the stacked register comprises:
an ALU register accessed by the first functional processing module; and
an FPU stack accessed by the stacker of the second functional processing module.

20. The operand-less instruction set architecture-based computer of claim 19, wherein the FPU stack comprises:
a register stack accessed by the stacker; and
an operation-only register operated by the ALU.
